(19) United States
(12) Patent Application Publication
(10) Pub. No.: US 2020/0334428 A1
(43) Pub. Date: Oct. 22, 2020

(54) BAGGAGE KEEPING SYSTEM AND COMPUTER PROGRAM PRODUCT

(71) Applicant: FUJITSU CLIENT COMPUTING LIMITED, Kanagawa (JP)

(72) Inventors: Keita Satou, Kawasaki (JP); Akemi Isobe, Kawasaki (JP); Koichi Ino, Kawasaki (JP)

(73) Assignee: FUJITSU CLIENT COMPUTING LIMITED, Kanagawa (JP)

(21) Appl. No.: 16/850,336

(22) Filed: Apr. 16, 2020

(30) Foreign Application Priority Data
Apr. 19, 2019 (JP) 2019-080114

(51) Int. Cl. G06K 7/10; G06Q 10/08

(52) U.S. Cl. CPC G06K 7/10366; G06Q 10/087

(57) ABSTRACT

A baggage keeping system includes a plurality of wireless tags, and an information processing device. The plurality of wireless tags are each detachably attached to baggage and include an operator that announces an activated state outward. The information processing device wirelessly communicates with the wireless tags. The information processing device includes circuity that implements a return information acquisition unit, and a command transmission unit. The return information acquisition unit acquires return information including wireless tag specifying information for specifying a wireless tag. The command transmission unit transmits a command to activate the operator of the wireless tag specified by the return information acquired by the return information acquisition unit. The operator of the wireless tag operates in response to the wireless tag receiving the command, wherein the wireless tag is a target of the command.

### CROSS-REFERENCE TO RELATED APPLICATIONS

This application is based upon and claims the benefit of priority from Japanese Patent Application No. 2019-080114, filed Apr. 19, 2019, the entire contents of which are incorporated herein by reference.

### FIELD

Embodiments described herein relate generally to a baggage keeping system and a computer program product.

### BACKGROUND

Conventionally, a baggage keeping system that is installed in such as a baggage checkroom and manages the kept baggage is known.

In this type of baggage keeping system, it is meaningful if a worker is easy to find the baggage that the worker searches for among the kept baggage.

### SUMMARY

According to an aspect of the present invention, a baggage keeping system includes a plurality of wireless tags, and an information processing device. The plurality of wireless tags are each detachably attached to baggage and include an operator capable of announcing an activated state outward. The information processing device is capable of wirelessly communicating with the wireless tags. The information processing device includes processing circuity (or circuitry) configured to implement a return information acquisition unit, and a command transmission unit. The return information acquisition unit acquires return information including wireless tag specifying information for specifying a wireless tag. The command transmission unit transmits a command to activate the operator of the wireless tag specified by the return information acquired by the return information acquisition unit. The operator of the wireless tag operates in response to the wireless tag receiving the command, the wireless tag being a target of the command.

According to another aspect of the present invention, a computer program product including programmed instructions embodied in and stored on a non-transitory computer readable medium. The instructions, when executed by a computer provided in an information processing device, case the computer to function as a return information acquisition unit and a command transmission unit. The information processing device is capable of wirelessly communicating with a plurality of wireless tags each detachably attached to baggage and including an operator capable of announcing an activated state outward. The return information acquisition unit acquires return information including wireless tag specifying information for specifying a wireless tag. The command transmission unit transmits a command to activate the operator of the wireless tag specified by the return information acquired by the return information acquisition unit.

### BRIEF DESCRIPTION OF THE DRAWINGS

FIG. 1 is a schematic diagram illustrating an example of a baggage keeping system according to an embodiment;

FIG. 2 is a side view of an example of a wireless tag according to an embodiment, and is a view of a state where a tag is attached to the wireless tag;

FIG. 3 is a schematic diagram illustrating an example of a configuration of the wireless tag according to the embodiment;

FIG. 4 is a schematic diagram illustrating an example of a power supply circuit and a pressing mechanism of a tag device according to an embodiment, in which the power supply circuit is in a conductive state;

FIG. 5 is a schematic diagram illustrating an example of the power supply circuit and the pressing mechanism of the tag device according to the embodiment, in which the power supply circuit is in a cut-off state;

FIG. 6 is a schematic diagram illustrating an example of a configuration of a terminal device according to an embodiment;

FIG. 7 is a diagram illustrating an example of a selection screen displayed by a UI unit of the terminal device according to the embodiment;

FIG. 8 is a diagram illustrating an example of a first keeping screen displayed by the UI unit of the terminal device according to the embodiment;

FIG. 9 is a diagram illustrating an example of a second keeping screen displayed by the UI unit of the terminal device according to the embodiment;

FIG. 10 is a diagram illustrating an example of a first return screen displayed by the UI unit of the terminal device according to the embodiment;

FIG. 11 is a diagram illustrating an example of a second return screen displayed by the UI unit of the terminal device according to the embodiment;

FIG. 12 is a diagram illustrating an example of a third return screen displayed by the UI unit of the terminal device according to the embodiment;

FIG. 13 is a diagram illustrating an example of a tag management screen displayed by the UI unit of the terminal device according to the embodiment, and is a diagram illustrating a case where there is a wireless tag with a low remaining battery level;

FIG. 14 is a diagram illustrating an example of a tag management screen displayed by the UI unit of the terminal device according to the embodiment and is a diagram illustrating a case where there is no wireless tag with a low remaining battery level;

FIG. 15 is a schematic diagram illustrating an example of a configuration of an information processing device according to an embodiment;

FIG. 16 is a flowchart illustrating an example of a flow of keeping processing executed by the baggage keeping system according to the embodiment; and

FIG. 17 is a flowchart illustrating an example of a flow of return processing executed by the baggage keeping system according to the embodiment.

### DETAILED DESCRIPTION

In the following, exemplary embodiments of the present disclosure are disclosed. In addition, a structure of embodiment illustrated below and the action and effect which are brought about by the structure are an example. Further, the following embodiments do not limit the disclosed technology.

Overall Configuration of Baggage Keeping System 1

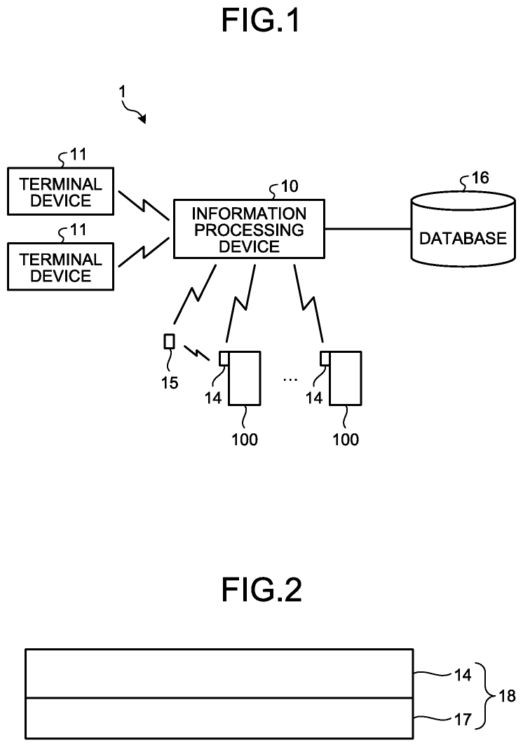

FIG. 1 is a schematic diagram illustrating an example of a baggage keeping system 1 according to the present embodiment.

The baggage keeping system 1 includes an information processing device 10, a terminal device 11, a plurality of wireless tags 14, a repeater 15, and a database 16 (storage device). The baggage keeping system 1 is installed, for example, in a baggage checkroom where baggage 100 is kept. The baggage checkroom includes, for example, a counter for delivering the baggage 100 between a worker and a customer, and a backyard (storage place) for storing the kept baggage 100. The information processing device 10 and the database 16 are installed, for example, at the backyard of the baggage checkroom. The terminal device 11 is installed, for example, at the counter of the baggage checkroom. The wireless tags 14 are stored in the counter or attached to the baggage 100. The information processing device 10 can wirelessly communicate with the terminal device 11, the wireless tags 14, and the repeater 15. In addition, the information processing device 10 and the database 16 can communicate with each other by wire. In addition, the information processing device 10, the terminal device 11, and the database 16 may be communicable by one or both of wireless and wired manner. In addition, the database 16 may be installed in a place other than the baggage checkroom.

As an example, a procedure for storing the baggage 100 at the baggage checkroom is as follows. When the worker receives the baggage 100 from a depositor, the worker attaches an arbitrary wireless tag 14 to the baggage 100. At this time, the worker inputs to the terminal device 11, depositor information for identifying the depositor and the tag number given to the wireless tag 14 attached to the baggage 100. The information input to the terminal device 11 is transmitted from the terminal device 11 to the information processing device 10 and managed by the information processing device 10. Then, the worker hands a tag 17 (FIG. 2) on which the tag number is written to the depositor, and stores the kept baggage 100 in the backyard. The tag number is an example of wireless tag specifying information for specifying the wireless tag 14.

On the other hand, a procedure for returning the baggage 100 is as follows, for example. When the worker receives the tag 17 from the depositor, the worker inputs the tag number written on the tag 17 into the terminal device 11. Information input to the terminal device 11 is transmitted from the terminal device 11 to the information processing device 10. The information processing device 10 causes the wireless tag 14 specified by the received information to execute a predetermined announcing operation. The worker carries the baggage 100 attached with the wireless tag 14 that has performed the predetermined announcing operation to the counter, removes the wireless tag 14, and returns the baggage to the depositor.

Wireless Tag 14

FIG. 2 is a side view of an example of a wireless tag 14 according to an embodiment, and is a view of a state where a tag 17 is attached to the wireless tag 14. The wireless tag 14 wirelessly communicates with the information processing device 10 directly or via the repeater 15. The wireless tag 14 is detachably attached to the baggage 100. For example, the wireless tag 14 is attached to the baggage 100 with an adhesive tape or attached to the baggage 100 with a string. Note that the means for attaching the wireless tag 14 to the baggage 100 (attachment tool) is not limited thereto. The wireless tag 14 is also referred to as a tag of various wireless standards such as a radio frequency identification (RFID) tag and a Bluetooth (registered trademark) low energy (BLE) tag, an electronic tag, and an IC tag.

A tag 17 is detachably coupled to the wireless tag 14. The tag 17 is detachably coupled to the wireless tag 14 by a claw or a fitting structure, for example. A tag number is written on the tag 17. A different tag number is set for each wireless tag 14. The wireless tag 14 and the tag 17 constitute a tag device 18. The tag number is an example of specific information for specifying the wireless tag 14.

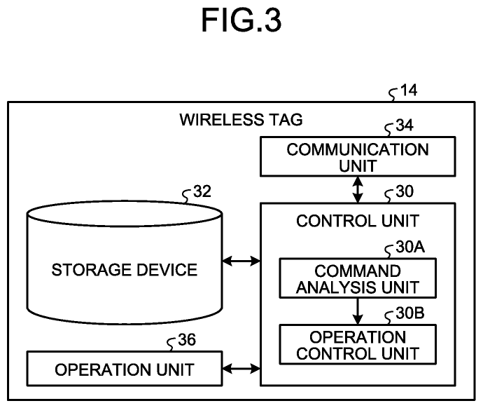

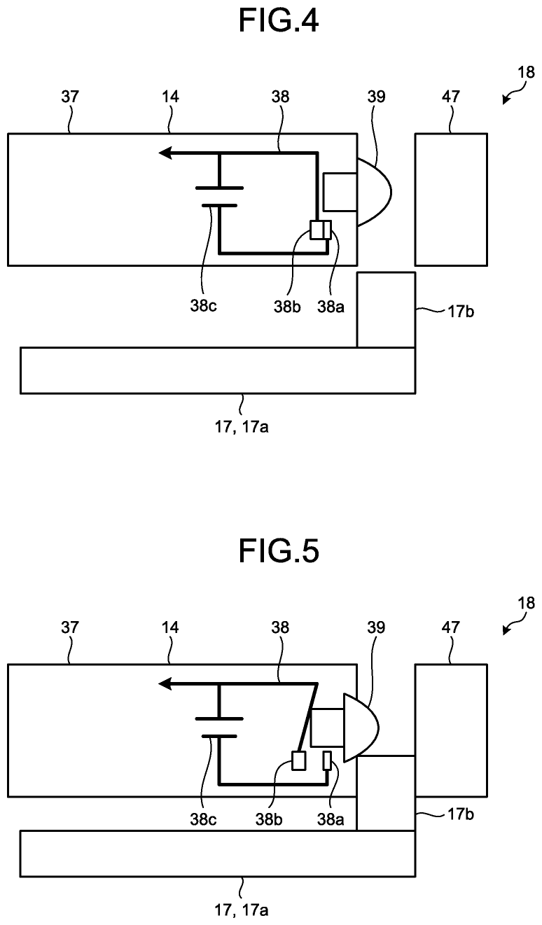

FIG. 3 is a schematic diagram illustrating an example of a configuration of the wireless tag 14 according to the embodiment. As illustrated in FIG. 3, the wireless tag 14 includes a control unit 30, a storage device 32, a communication unit 34, and an operation unit (operator) 36. The control unit 30, the storage device 32, the communication unit 34, and the operation unit 36 are accommodated in a housing 37 (FIG. 4) of the wireless tag 14. The control unit 30, the storage device 32, the communication unit 34, and the operation unit 36 are connected so as to be able to exchange data or signals.

The storage device 32 stores various types of information. In the present embodiment, the storage device 32 stores a tag number set in the wireless tag 14 provided with the storage device 32. The storage device 32 is a known storage medium.

The communication unit 34 is a communication interface for communicating with other devices. For example, the communication unit 34 is a communication interface for wirelessly communicating with the information processing device 10.

The operation unit 36 performs an operation capable of announcing an activated state to the outside. Specifically, the operation of the operation unit 36 is accompanied by state changes that can be perceived by a person through physical sensations, such as light emission, sound output, vibration generation, and form change. The form change means that at least one of color, shape, and size changes.

The operation unit 36 has a configuration for performing the operation. That is, the operation unit 36 includes, for example, a light, a speaker, a vibration device, a drive mechanism for form change, and the like. Note that, the operation unit 36 may be any device that realizes at least one of light emission, sound output, vibration generation, and form change.

The control unit 30 includes a central processing unit (CPU), a read only memory (ROM), and a random access memory (RAM). That is, the control unit 30 is a computer. The CPU reads and executes a program stored in the ROM or the like. Further, the CPU is configured to be able to perform various arithmetic processes in parallel. The RAM temporarily stores various data used when the CPU executes programs and executes various arithmetic processes.

The control unit 30 includes a command analysis unit 30A and an operation control unit 30B as functional configurations. These functional configurations are realized as a result of the CPU executing a program stored in a ROM or the like. Note that part or all of the functional configurations may be realized by dedicated hardware (circuit).

The command analysis unit 30A receives the command transmitted from the information processing device 10 via the communication unit 34. That is, the command analysis unit 30A acquires the command from the information processing device 10. The command analysis unit 30A analyzes the received command. Details of the command will be described later. When the wireless tag 14 provided with the command analysis unit 30A is a command target, the command analysis unit 30A transmits the command to the operation control unit 30B. When the wireless tag 14 provided with the command analysis unit 30A is not the command target, the command analysis unit 30A does not transmit the command to the operation control unit 30B. The command analysis unit 30A is also referred to as a command reception unit.

When receiving the command from the command analysis unit 30A, the operation control unit 30B controls the operation unit 36 so that the operation unit 36 operates according to the content of the command. Thereby, the operation unit 36 performs an operation according to the command.

FIG. 4 is a schematic diagram illustrating an example of a power supply circuit 38 and a pressing mechanism 47 of the tag device 18 according to the embodiment, in which the power supply circuit 38 is in a conductive state. FIG. 5 is a schematic diagram illustrating an example of the power supply circuit 38 and the pressing mechanism 47 of the tag device 18 according to the embodiment, in which the power supply circuit 38 is in a cut-off state.

As illustrated in FIGS. 4 and 5, the wireless tag 14 includes a power supply circuit 38. The power supply circuit 38 is accommodated in the housing 37 of the wireless tag 14. The power supply circuit 38 includes a fixed contact portion 38a, a movable contact portion 38b, and a battery 38c. The battery 38c is a power source that supplies power to each unit (the control unit 30, the storage device 32, and the operation unit 36) of the wireless tag 14. The fixed contact portion 38a is fixed to the housing 37. The movable contact portion 38b is supported by the housing 37 so as to be able to contact with and separate from the fixed contact portion 38a, and is elastically pressed toward the fixed contact portion 38a by an elastic member such as a spring (not illustrated). The state where the fixed contact portion 38a and the movable contact portion 38b are in contact with each other is a conductive state of the power supply circuit 38, and in such state, the power can be supplied to each unit of the wireless tag 14 from the battery 38c. In such a state, the power is supplied by turning on a power button (not illustrated). On the other hand, the state where the fixed contact portion 38a and the movable contact portion 38b are separated from each other is a cut-off state of the power supply circuit 38, and in such state, the power is not supplied to each unit of the wireless tag 14 from the battery 38c.

In addition, the tag device 18 includes a pressing mechanism 47 that moves the movable contact portion 38b. The pressing mechanism 47 includes a movable member 39 provided on the wireless tag 14 and a protrusion 17b provided on the tag 17. The movable member 39 is supported by the housing 37 so as to be movable with respect to the fixed contact portion 38a. The movable member 39 is movable between a non-pressing position where the movable contact portion 38b is not pressed (FIG. 4) and a pressing position where the movable contact portion 38b is pressed in a direction away from the fixed contact portion 38a (FIG. 5). Further, the movable member 39 is elastically pressed in a direction from the pressing position to the non-pressing position (right direction in FIGS. 4 and 5) by an elastic member such as a spring (not illustrated). Further, the protrusion 17b protrudes from a plate-like base 17a of the tag 17.

In the above-mentioned configuration, when the tag 17 is removed from the wireless tag 14, the movable member 39 is positioned at the non-pressing position (FIG. 4), the fixed contact portion 38a and the movable contact portion 38b are in contact with each other, and the power supply circuit 38 is in the conductive state. From such a state, in a case in which the tag 17 is attached to the wireless tag 14, in the attachment process, the movable member 39 is pressed by the protrusion 17b and moves from the non-pressing position to the pressing position, and presses the movable contact portion 38b to separate the movable contact portion 38b from the fixed contact portion 38a (FIG. 5). As a result, the power supply circuit 38 is in the cut-off state.

The power supply circuit 38 includes a voltage detection unit (not illustrated) of the battery 38c. For example, the control unit 30 transmits a voltage of the battery 38c detected by the detection unit to the information processing device 10 and the terminal device 11 via the communication unit 34. At this time, the control unit 30 may transmit the voltage in response to a request from the information processing device 10 and the terminal device 11, or may transmit the voltage at regular intervals. From such a voltage, a charged amount (remaining battery amount) of the battery 38c is calculated.

Terminal Device 11

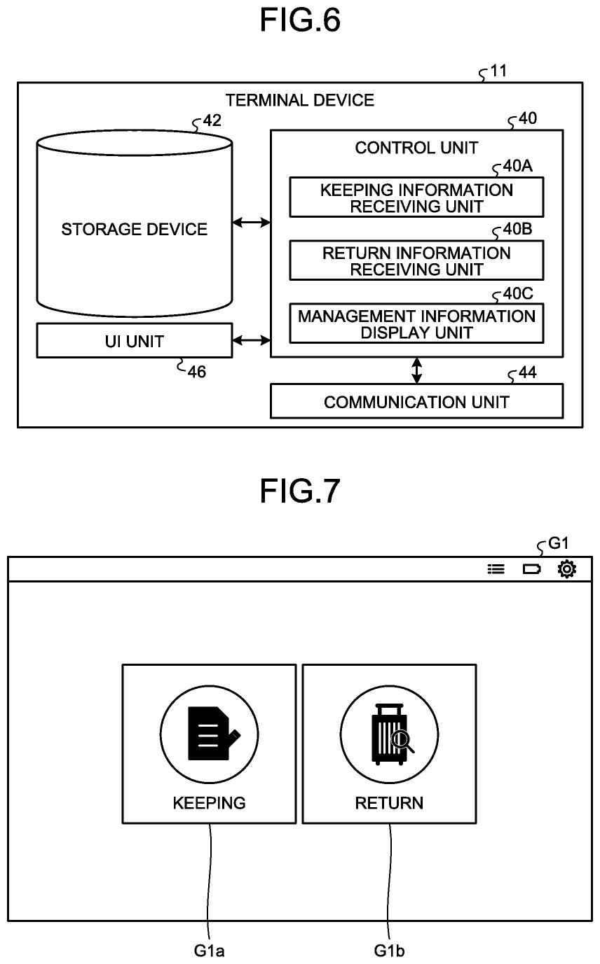

FIG. 6 is a schematic diagram illustrating an example of a configuration of the terminal device 11 according to the embodiment.

As illustrated in FIG. 6, the terminal device 11 includes a control unit 40, a storage device 42, a communication unit 44, and a user interface (UI) unit 46. The control unit 40, the storage device 42, the communication unit 44, and the UI unit 46 are connected so as to be able to exchange data or signals.

The storage device 42 stores various types of information. The storage device 42 is a known storage medium such as a hard disk drive (HDD) or a solid state drive (SSD).

The communication unit 44 is a communication interface for communicating with the information processing device 10.

The UI unit 46 includes an input function that receives an operation instruction from an operator such as a worker, and a display function that displays an image. The input function is, for example, a keyboard, a mouse, or the like. The display function is, for example, a liquid crystal display device, an organic electroluminescence (EL) display, or the like. The UI unit 46 may be a display with a touch panel that integrally includes the input function and the display function.

The control unit 40 includes a central processing unit (CPU), a read only memory (ROM), and a random access memory (RAM). The CPU may be another hardware processor such as a graphics processing unit (GPU). That is, the control unit 40 has a general computer hardware configuration. The CPU reads and executes a program stored in the ROM or the like. Further, the CPU is configured to be able to perform various arithmetic processes in parallel. The RAM temporarily stores various data used when the CPU executes programs and executes various arithmetic processes.

The control unit 40 includes a keeping information receiving unit 40A, a return information receiving unit 40B, and a management information display unit 40C as functional configurations. These functional configurations are realized as a result of the CPU executing a program stored in a ROM or the like. Note that part or all of the functional configurations may be realized by dedicated hardware (circuit).

The keeping information receiving unit 40A receives an input of keeping information, and transmits the keeping information that has been received the input to the information processing device 10 via the communication unit 44. The keeping information includes baggage specifying information for specifying the baggage 100 and wireless tag specifying information for the wireless tag 14 attached to the baggage 100. Further, the baggage specifying information includes, for example, depositor specifying information that specifies a depositor of the baggage 100. The depositor specifying information includes a name, a telephone number of a mobile phone, an address, a sex, and an age of the depositor, and unique information held by the depositor related thereto. In addition, the keeping information also includes a reception time when the input is received.

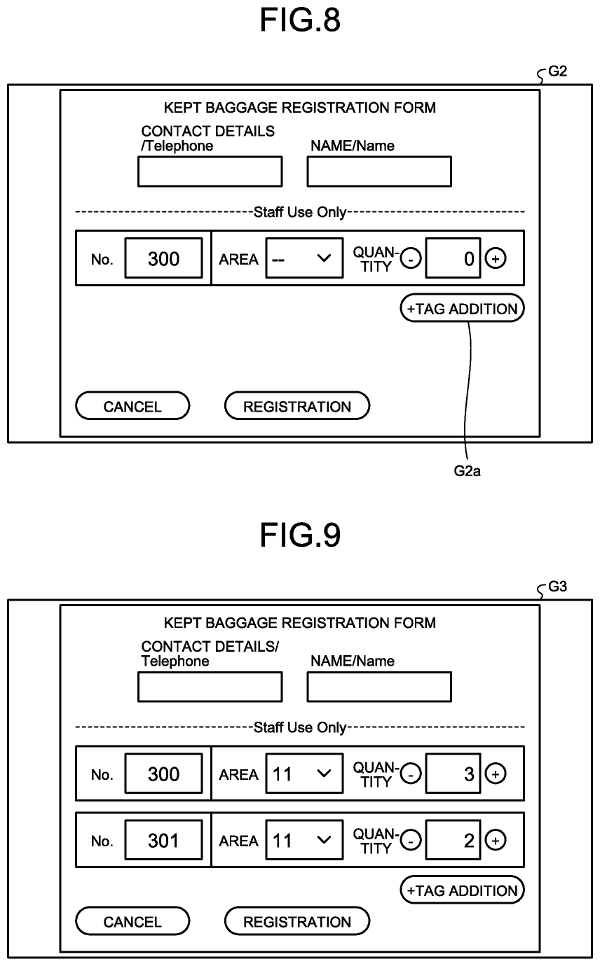

FIG. 7 is a diagram illustrating an example of a selection screen G1 displayed by the UI unit 46 of the terminal device 11 according to the embodiment. FIG. 8 is a diagram illustrating an example of a first keeping screen G2 displayed by the UI unit 46 of the terminal device 11 according to the embodiment. FIG. 9 is a diagram illustrating an example of a second keeping screen G3 displayed by the UI unit 46 of the terminal device 11 according to the embodiment.

When a keeping button G1a on the selection screen G1 (FIG. 7) displayed on the display device of the UI unit 46 is operated, the keeping information receiving unit 40A displays a first keeping screen G2 (FIG. 8) that receive the input of keeping information on the display device of the UI unit 46. In addition, when a tag addition button G2a on the first keeping screen G2 is operated, the keeping information receiving unit 40A displays a second keeping screen G3 (FIG. 9) that receives the input of keeping information on the display device of the UI unit 46. The second keeping screen G3 receives an input of a plurality of tag numbers (“No.” in the figure). The keeping information receiving unit 40A transmits the keeping information that has been received the input on the first keeping screen G2 or the second keeping screen G3 to the information processing device 10.

The return information receiving unit 40B receives an input of return information, and transmits the return information that has received the input to the information processing device 10 via the communication unit 44. The return information includes at least one of baggage specifying information and wireless tag specifying information. The return information also includes terminal device specifying information for specifying the terminal device 11 that transmits the return information. In addition, a return information acquisition unit 20B includes the time when the input is received.

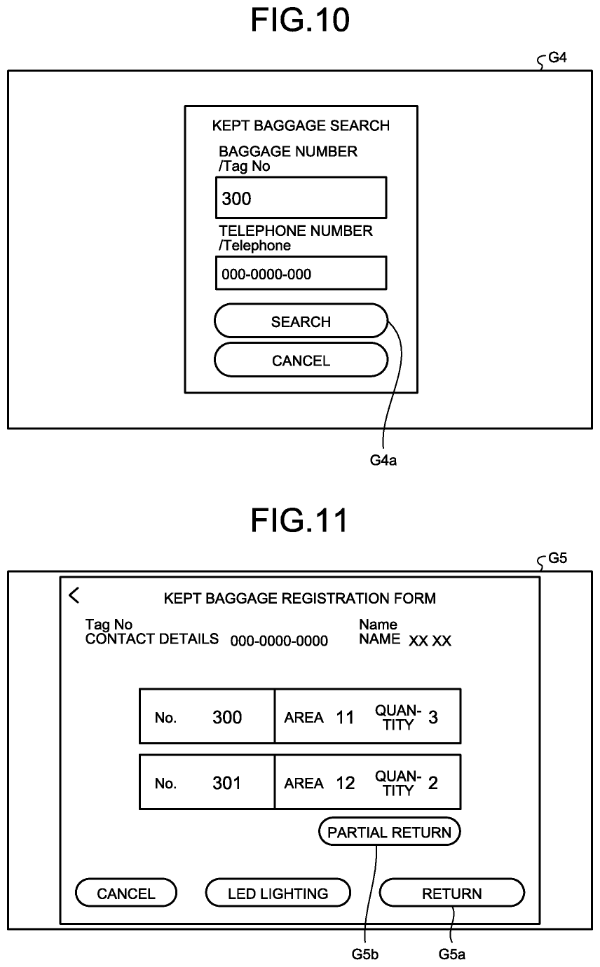

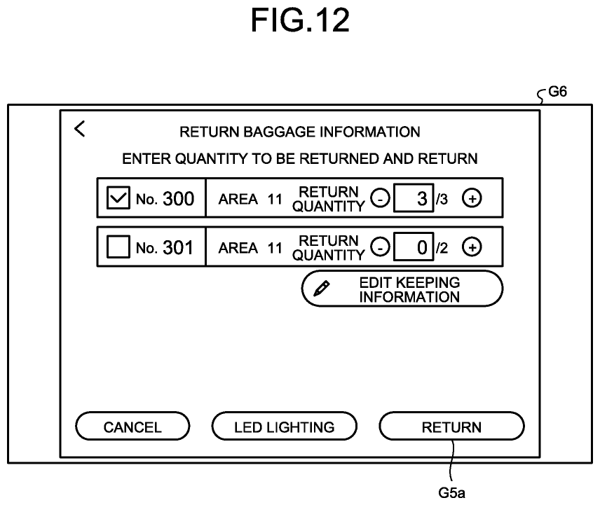

FIG. 10 is a diagram illustrating an example of a first return screen G4 displayed by the UI unit 46 of the terminal device 11 according to the embodiment. FIG. 11 is a diagram illustrating an example of a second return screen G5 displayed by the UI unit 46 of the terminal device 11 according to the embodiment. FIG. 12 is a diagram illustrating an example of a third return screen G6 displayed by the UI unit 46 of the terminal device 11 according to the embodiment.

When a return button G1b on the selection screen G1 (FIG. 7) displayed on the display device of the UI unit 46 is operated, the return information receiving unit 40B displays a first return screen G4 (FIG. 10) that receives an input of return information on the display device of the UI unit 46. In addition, when a search button G4a on the first return screen G4 is operated, the return information receiving unit 40B displays a second return screen G5 (FIG. 11) on the display device of the UI unit 46. When a return button G5a on the second return screen G5 is operated, the return information receiving unit 40B transmits return information corresponding to the tag number displayed on the second return screen G5 to the information processing device 10. In addition, when a partial return button G5b of the second return screen G5 is operated, the return information receiving unit 40B displays a third return screen G6 (FIG. 12) on the display device of the UI unit 46. The third return screen G6 is a screen for receiving selection of a tag number, and the return information receiving unit 40B transmits return information corresponding to the selected tag number to the information processing device 10.

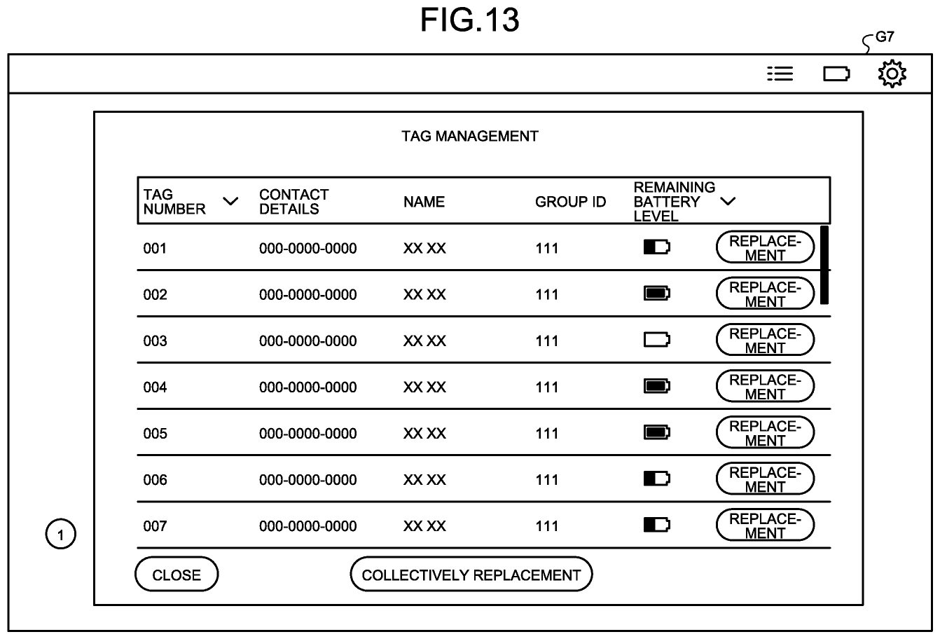

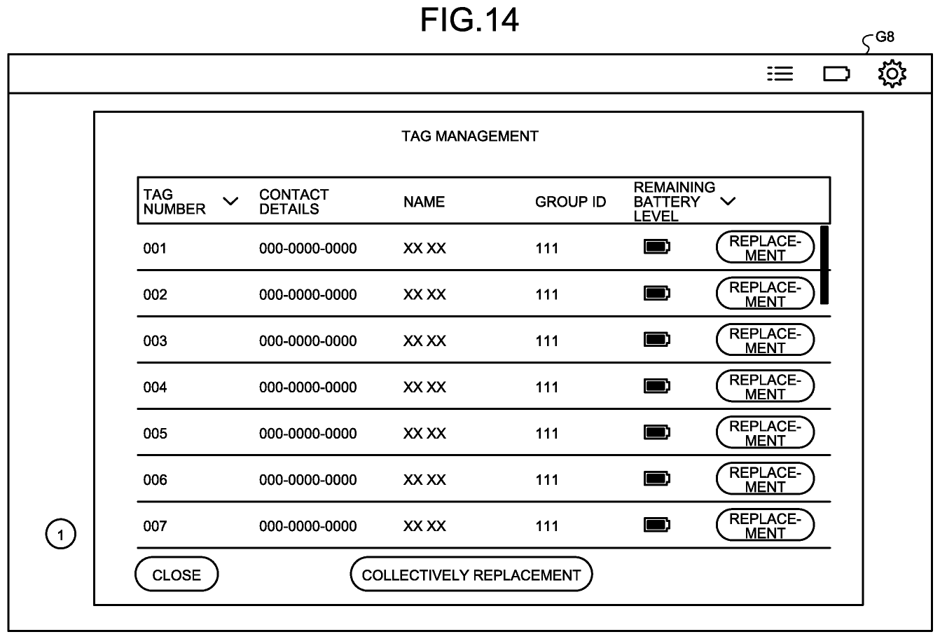

FIG. 13 is a diagram illustrating an example of a tag management screen G7 displayed by the UI unit 46 of the terminal device 11 according to the embodiment, and is a diagram illustrating a case where there is a wireless tag 14 with a low remaining battery level. FIG. 14 is a diagram illustrating an example of a tag management screen G8 displayed by the UI unit 46 of the terminal device 11 according to the embodiment, and is a diagram illustrating a case where there is no wireless tag 14 with a low remaining battery level.

The management information display unit 40C displays the tag management screens G7 and G8 illustrated in FIGS. 13 and 14 on the display device of the UI unit 46. On the tag management screens G7 and G8, the baggage specifying information and the remaining battery level are displayed for each tag number (wireless tag 14). The term of the wireless tag 14 with remaining battery amount of a threshold value or less is illustrated in yellow, for example, and the term of the wireless tag 14 with remaining battery amount of zero is illustrated in red, for example. Since the wireless tag 14 having no remaining battery level cannot transmit voltage information, it is determined that the remaining battery level of the wireless tag 14 is zero if radio waves from the wireless tag 14 are not received for a certain period of time. The information processing device 10 performs determination and management (storage) of the remaining battery level, and transmits management information such as a determination result to the terminal device 11. Based on such management information, the tag management screens G7 and G8 are displayed.

Information Processing Device 10

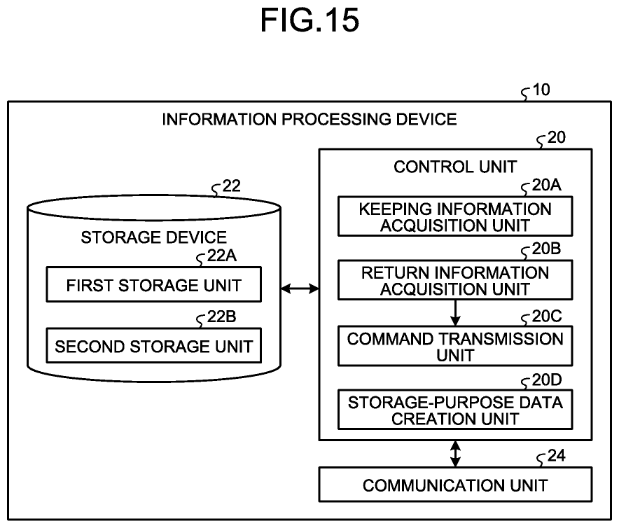

FIG. 15 is a schematic diagram illustrating an example of a configuration of the information processing device 10 according to the embodiment.

As illustrated in FIG. 15, the information processing device 10 includes a control unit 20, a storage device 22, and a communication unit 24. The control unit 20, the storage device 22, and the communication unit 24 are connected so as to be able to exchange data or signals. Note that the information processing device 10 may include a UI unit in the same manner as the terminal device 11. The information processing device 10 is also referred to as a management terminal.

The storage device 22 stores various types of information. In the present embodiment, the storage device 22 includes a first storage unit (first storage) 22A that stores keeping information, return information, and the like, and a second storage unit (second storage) 22B that stores usage status information indicating a usage status of the wireless tag 14. The first storage unit 22A stores the baggage specifying information and the wireless tag specifying information included in the keeping information in association with each other. In the first storage unit 22A, the wireless tag 14, in association with the wireless tag specifying information of which the baggage specifying information is stored is in use, and the wireless tag 14, in association with the wireless tag specifying information which the baggage specifying information is not stored is not in use. The usage status information is represented by, for example, a return flag. When the return flag is set, the wireless tag 14 is not in use, and when the return flag is not set, the wireless tag 14 is in use. The first storage unit 22A and the second storage unit 22B are also referred to as storage areas. The storage device 22 is a known storage medium such as a hard disk drive (HDD). Note that the storage device 22 may be provided in an external device.

The communication unit 24 is a communication interface for communicating with the terminal device 11 and the wireless tag 14. The communication unit 24 may communicate with the wireless tag 14 via the repeater 15. For example, the repeater 15 transfers received data to the wireless tag 14 only once.

The control unit 20 includes a CPU, a ROM, and a RAM. That is, the control unit 20 is a computer. The CPU may be another hardware processor such as a graphics processing unit (GPU). The CPU reads and executes a program stored in the ROM or the like. Further, the CPU is configured to be able to perform various arithmetic processes in parallel. The RAM temporarily stores various data used when the CPU executes programs and executes various arithmetic processes.

The control unit 20 includes a keeping information acquisition unit 20A, a return information acquisition unit 20B, a command transmission unit 20C, and a storage-purpose data creation unit 20D, as functional configurations. These functional configurations are realized as a result of the CPU executing a program stored in a ROM or the like. Note that part or all of the functional configurations may be realized by dedicated hardware (circuit).

The keeping information acquisition unit 20A receives keeping information from the keeping information receiving unit 40A of the terminal device 11 via the communication unit 24. That is, the keeping information acquisition unit 20A acquires the keeping information. The keeping information acquisition unit 20A stores, in the first storage unit 22A, the baggage specifying information included in the keeping information from the keeping information receiving unit 40A and the wireless tag specifying information included in the keeping information in association with each other.

When the usage status information stored in the second storage unit 22B indicates that the wireless tag 14 specified by the wireless tag specifying information included in the keeping information from the keeping information receiving unit 40A is not in use, the keeping information acquisition unit 20A stores, in the first storage unit 22A, the baggage specifying information included in the keeping information and the wireless tag specifying information included in the keeping information in association with each other. On the other hand, when the usage status information stored in the second storage unit 22B indicates that the wireless tag 14 specified by the wireless tag specifying information included in the keeping information from the keeping information receiving unit 40A is in use, the keeping information acquisition unit 20A does not associate the baggage specifying information included in the keeping information and the wireless tag specifying information included in the keeping information. In this case, the keeping information acquisition unit 20A transmits error information to the terminal device 11 by including the error information in a confirmation result described later.

The return information acquisition unit 20B receives return information including the wireless tag specifying information for specifying the wireless tag 14 from the return information receiving unit 40B of the terminal device 11 via the communication unit 24. That is, the return information acquisition unit 20B acquires the return information. The return information acquisition unit 20B transmits the received (acquired) return information to the command transmission unit 20C.

The command transmission unit 20C transmits a command to activate the operation unit 36 of the wireless tag 14 specified by the return information from the return information acquisition unit 20B. The command transmission unit 20C broadcasts the command. Note that the command transmission unit 20C may transmit the command only to the target wireless tag 14. The command includes wireless tag specifying information, operation content, and the like of the wireless tag 14 to be activated. The operation content includes light emission, sound output, vibration generation, form change, and the like. Further, the command has different operation contents for each terminal device 11 specified by the terminal device specifying information included in the return information. For example, in the case of light emission, different blinking intervals or colors are used, and in the case of sound, different sounds are used.

The storage-purpose data creation unit 20D creates storage-purpose data obtained by converting at least part of the depositor specifying information into a numerical value. For example, the storage-purpose data creation unit 20D creates the storage-purpose data for only information that cannot specify an individual by only sex, country, or the like among the depositor specifying information. The numerical value conversion is performed based on a preset correspondence table. For example, for the sex, a numerical value corresponding to the male and the female are set. The storage-purpose data creation unit 20D stores the converted numerical value in the storage device 22 or the database 16 as text data arranged in a line.

Keeping Processing

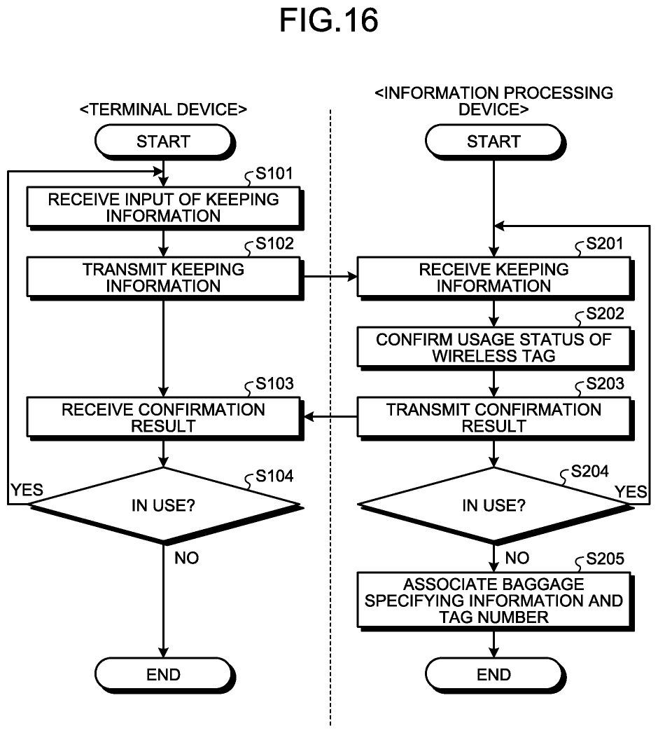

Next, keeping processing executed by the baggage keeping system 1 will be described. FIG. 16 is a flowchart illustrating an example of a flow of keeping processing executed by the baggage keeping system 1 according to the embodiment.

As illustrated in FIG. 16, the keeping information receiving unit 40A of the terminal device 11 receives an input of keeping information (S101). The keeping information receiving unit 40A transmits the keeping information that has been received to the information processing terminal (S102).

In the information processing device 10, the keeping information acquisition unit 20A receives the keeping information transmitted from the keeping information receiving unit 40A (S201). The keeping information acquisition unit 20A refers to the usage status information stored in the second storage unit 22B, and confirms the usage status of the wireless tag 14 specified by the wireless tag specifying information included in the keeping information from the keeping information receiving unit 40A (S202). The keeping information acquisition unit 20A transmits the confirmation result, that is, the usage status of the wireless tag 14 to the terminal device 11 (S203).

When the wireless tag 14 is not in use (S204: No), the keeping information acquisition unit 20A stores, in the first storage unit 22A, the baggage specifying information included in the keeping information and the wireless tag specifying information included in the keeping information in association with each other (S205).

On the other hand, when the wireless tag 14 is in use (S204: Yes), the keeping information acquisition unit 20A does not associate the baggage specifying information included in the keeping information with the wireless tag specifying information included in the keeping information and returns to S201.

In the terminal device 11, the keeping information receiving unit 40A receives the confirmation result transmitted from the keeping information acquisition unit 20A (S103). When the wireless tag 14 is not in use (S104: No), the keeping information receiving unit 40A ends the processing. On the other hand, when the wireless tag 14 is in use (S104: Yes), the keeping information receiving unit 40A returns to S101 and receives the input of keeping information again.

Return Processing

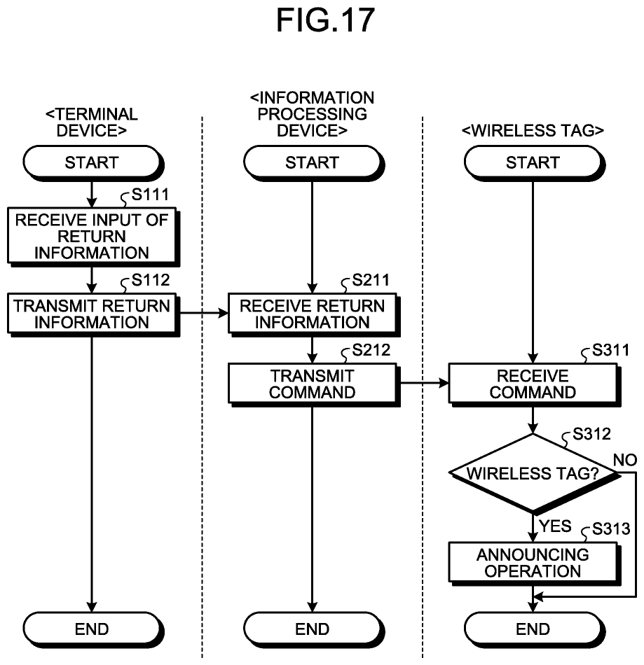

Next, return processing executed by the baggage keeping system 1 will be described. FIG. 17 is a flowchart illustrating an example of a flow of return processing executed by the baggage keeping system 1 according to the embodiment.

As illustrated in FIG. 17, the return information receiving unit 40B of the terminal device 11 receives an input of return information (S111). The return information receiving unit 40B transmits the return information that has received the input to the information processing terminal (S112).

In the information processing device 10, the return information acquisition unit 20B receives the return information transmitted from the return information receiving unit 40B (S211). The return information acquisition unit 20B transmits the received (acquired) return information to the command transmission unit 20C.

The command transmission unit 20C creates a command to activate the operation unit 36 of the wireless tag 14 specified by the return information from the return information acquisition unit 20B, and broadcasts the created command (S212).

In the wireless tag 14, the command analysis unit 30A receives the command transmitted from the command transmission unit 20C of the information processing device 10 (S311). The command analysis unit 30A determines whether or not a target of the command is the wireless tag 14 provided with the command analysis unit 30A (S312). When the target of the command is the wireless tag 14 provided with the command analysis unit 30A (S312: Yes), the command analysis unit 30A transmits the command to the operation control unit 30B.

When receiving the command from the command analysis unit 30A, the operation control unit 30B controls the operation unit 36 based on the content of the command to cause the operation unit 36 to perform an announcing operation (S313). Thereby, the operation unit 36 performs the announcing operation according to the command. Note that when a stop button (not illustrated) of the wireless tag 14 is operated by the worker, the operation unit 36 stops the announcing operation. In addition, when the worker returns the baggage 100 to the depositor, the worker couples the wireless tag 14 and the tag 17 to each other. Further, when a return button G5a (FIGS. 11 and 12) is operated by the worker, the information including the keeping information and the return information is stored in the storage unit such as the database 16. Note that the information may include an operation start time and an operation end time of the operation unit 36.

On the other hand, when the target of the command is not the wireless tag 14 provided with the command analysis unit 30A (S312: No), the command analysis unit 30A does not transmit the command to the operation control unit 30B. That is, the operation unit 36 does not operate.

Preparation Before Use

Before storing the baggage 100, that is, before using the wireless tag 14, the worker logs in to the information processing device 10 from the terminal device 11 and confirms an operation status of each wireless tag 14. The worker confirms whether the power of the wireless tag 14 to be used is turned on. If the power is turned on, the worker confirms the remaining battery level of the wireless tag 14. If there is no problem with the remaining battery level, the worker uses the wireless tag 14.

On the other hand, if the power of the wireless tag 14 to be used is not turned on, the worker presses a power button (not illustrated) of the wireless tag 14 to turn on the power. If the power is turned on and an LED (not illustrated) emits light, the worker confirms the remaining battery level of the wireless tag 14. If there is no problem with the remaining battery level, the worker uses the wireless tag 14. If the LED (not illustrated) does not emit the light even when the power is turned on, the worker replaces the battery 38c because the battery has run out. Then, the power is turned on again and the above-mentioned processing is repeated.

As described above, the baggage keeping system 1 according to the embodiment includes, for example, the plurality of wireless tags 14 that are detachably attached to the baggage 100 and include the operation unit 36 that can announce the activated state to the outside, and the information processing device 10 capable of wirelessly communicating with the wireless tags 14. The information processing device 10 includes the return information acquisition unit 20B that acquires the return information including the wireless tag specifying information that specifies the wireless tag 14, and the command transmission unit 20C for transmitting the command to activate the operation unit 36 of the wireless tag 14 specified by the return information acquired by the return information acquisition unit 20B. When the wireless tag 14 that is the target of the command receives the command, the operation unit 36 of the wireless tag 14 operates.

According to such a baggage keeping system 1, since only the operation unit 36 of the wireless tag 14 attached to the baggage 100 that the worker searches for can be activated, it is easy for the worker to find the baggage 100 that the worker searches among the kept baggage 100. In addition, since this makes it possible to improve work efficiency and reduce the amount of work, it is possible to secure workers, improve satisfaction of the workers, and improve satisfaction of the depositors who are customers. In addition, since the baggage 100 can be easily managed, the number of received baggage 100 can be increased, and profits can be improved.

In addition, since it is not necessary to use paper for managing the baggage 100 by managing the baggage 100 using the wireless tag 14 in this way, the use of paper can be reduced.

In the baggage keeping system 1 according to the embodiment, for example, the command transmission unit 20C broadcasts the command.

According to such a baggage keeping system 1, for example, the command transmission unit 20C does not need to limit a transmission destination of the command every time the command is transmitted.

In addition, the baggage keeping system 1 according to the embodiment includes the terminal device 11 that can communicate with the information processing device 10, for example. The terminal device 11 receives the input of the keeping information including the baggage specifying information that specifies the baggage 100 and the wireless tag specifying information of the wireless tag 14 attached to the baggage 100, and includes the keeping information receiving unit 40A for transmitting the keeping information that has been received the input to the information processing device 10. The information processing device 10 includes the keeping information acquisition unit 20A that stores, in the first storage unit 22A, the baggage specifying information included in the keeping information from the keeping information receiving unit 40A and the wireless tag specifying information included in the keeping information in association with each other.

According to such a baggage keeping system 1, for example, the terminal device 11 and the information processing device 10 can be installed at different places.

In addition, the baggage keeping system 1 according to the embodiment includes a plurality of terminal devices 11, for example. The command instructs the operation unit 36 to perform different operations for each terminal device 11.

According to such a baggage keeping system 1, it is easy for the worker to search for the wireless tag 14 corresponding to the terminal device 11 for which the worker has performed the input operation.

In addition, in the baggage keeping system 1 according to the embodiment, for example, when the usage status information stored in the second storage unit 22B indicates that the wireless tag 14 specified by the wireless tag specifying information included in the keeping information from the keeping information receiving unit 40A is not in use, the keeping information acquisition unit 20A stores, in in the first storage unit 22A, the baggage specifying information included in the keeping information and the wireless tag specifying information included in the keeping information in association with each other. When the usage status information stored in the second storage unit 22B indicates that the wireless tag 14 specified by the wireless tag specifying information included in the keeping information from the keeping information receiving unit 40A is in use, the keeping information acquisition unit 20A does not associate the baggage specifying information included in the keeping information and the wireless tag specifying information included in the keeping information.

According to such a baggage keeping system 1, for example, since the baggage specifying information of another baggage 100 is not erroneously associated with the wireless tag 14, even when the worker erroneously inputs the wireless tag specifying information of the wireless tag 14 being used in the terminal device 11, the baggage 100 can be properly managed.

Further, in the baggage keeping system 1 according to the embodiment, for example, the keeping information includes the depositor specifying information that specifies the depositor of the baggage 100, and the information processing device 10 includes the storage-purpose data creation unit 20D that creates the storage-purpose data in which at least a part of the depositor specifying information is converted into a numerical value.

According to such a baggage keeping system 1, for example, a data amount of storage-purpose data can be made relatively small. In addition, such storage-purpose data is easy to use for constructing, for example, a feature point filter of artificial intelligence (AI). In addition, by deleting information other than the storage-purpose data creation unit 20D, it is possible to suppress the leakage of personal information.

Note that the program for executing the processing executed by the information processing device 10, the terminal device 11, and the wireless tag 14 may be stored in a computer-readable storage medium such as a CD-ROM, CD-R, a memory card, a digital versatile disk (DVD), a flexible disk (FD), or the like in an installable format or an executable format file and provided as a computer program product. In addition, the program for executing the processing executed by the information processing device 10, the terminal device 11, and the wireless tag 14 may be stored on a computer connected to a network such as the Internet and provided by being downloaded via the network. In addition, the program for executing the processing executed by the information processing device 10, the terminal device 11, and the wireless tag 14 may be provided or distributed via the network such as the Internet.

According to an embodiment, it is possible to make it easier for the worker to search for the baggage that the worker searches for among the kept baggage.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A baggage keeping system comprising:
a plurality of wireless tags each detachably attached to baggage and including an operator that announces an activated state outward; and
an information processing device that wirelessly communicates with the wireless tags, wherein
the information processing device comprises circuitry that:
acquires return information including wireless tag specifying information for specifying a wireless tag; and
transmits a command to activate the operator of the wireless tag specified by the acquired return information, and
the operator of the wireless tag operates in response to the wireless tag receiving the command, wherein the wireless tag is a target of the command.

2. The baggage keeping system according to claim 1, wherein the circuitry of the information processing device broadcasts the command.

3. The baggage keeping system according to claim 1, further comprising:
a terminal device that communicates with the information processing device, wherein
the terminal device comprises circuitry that transmits, to the information processing device, keeping information including baggage specifying information for specifying the baggage and the wireless tag specifying information of the wireless tag attached to the baggage, and
the circuitry of the information processing device further stores, in a first storage, the baggage specifying information included in the transmitted keeping information and the wireless tag specifying information included in the keeping information in association with each other.

4. The baggage keeping system according to claim 3, wherein
the terminal device includes a plurality of terminal devices, and
the command instructs the operator to perform a different operation for each terminal device.

5. The baggage keeping system according to claim 3, wherein
the circuitry of the information processing device further stores, in the first storage, the baggage specifying information included in the keeping information and the wireless tag specifying information included in the keeping information in association with each other, when usage status information stored in a second storage that stores the usage status information indicating whether or not the wireless tag is in use indicates that the wireless tag specified by the wireless tag specifying information included in the transmitted keeping information is not in use, and
the circuitry of the information processing device does not associate the baggage specifying information included in the keeping information and the wireless tag specifying information included in the keeping information, when the usage status information stored in the second storage indicates that the wireless tag specified by the wireless tag specifying information included in the transmitted keeping information is in use.

6. The baggage keeping system according to claim 3, wherein the keeping information includes depositor specifying information for specifying a depositor of the baggage, and
the circuitry of the information processing device further creates storage-purpose data obtained by converting at least a part of the depositor specifying information into a numerical value.

7. A computer program product including programmed instructions embodied in and stored on a non-transitory computer readable medium, the instructions cause a computer provided in an information processing device capable of wirelessly communicating with a plurality of wireless tags each detachably attached to baggage and including an operator capable of announcing an activated state outward executing the instructions to:
acquire return information including wireless tag specifying information for specifying a wireless tag; and
transmit a command to activate the operator of the wireless tag specified by the acquired return information.
